(19) United States
(12) Patent Application Publication
(10) Pub. No.: US 2018/0326853 A1
(43) Pub. Date: Nov. 15, 2018

(54) SOLAR TRACKING ELECTRIC VEHICLE

(71) Applicant: UNIVERSITY OF KWAZULU-NATAL, Westville (ZA)

(72) Inventors: CLINTON PIERRE BEMONT, DURBAN (ZA); KIRSTY LYNN VEALE, DURBAN (ZA)

(73) Assignee: UNIVERSITY OF KWAZULU-NATAL, Westville (ZA)

(21) Appl. No.: 15/755,813

(22) PCT Filed: Aug. 19, 2016
(86) PCT No.: PCT/IB2016/054967

§ 371 Date: Feb. 27, 2018

(30) Foreign Application Priority Data
Aug. 27, 2015 (GB) 1515247.3

(51) Int. Cl. B60L 8/00; B60K 16/00; B60G 17/04; H02S 10/40; H02S 20/32

(52) U.S. Cl. CPC B60L 8/003; B60K 16/00; B60G 17/04; H02S 10/40; B60G 2500/30; B60K 2016/003; B60G 2200/10; B60G 2300/50; H02S 20/32

(57) ABSTRACT

This invention relates to an electric vehicle and more particularly, but not exclusively, to a solar vehicle of which a chassis is selectively adjustable relative to wheels of the vehicle. The electric vehicle includes a chassis, a suspension arrangement for connecting the chassis to wheels of the vehicle, and a solar panel securable relative to the chassis. The vehicle is characterized in that an orientation of the chassis relative to a plane defined by the wheels of the vehicle can be selectively adjusted by adjusting the suspension arrangement, in order for the angular orientation of the solar panel also to be adjusted.

### BACKGROUND TO THE INVENTION

THIS invention relates to an electric vehicle and more particularly, but not exclusively, to a solar tracking electric vehicle of which a chassis is selectively adjustable relative to wheels of the vehicle.

An electric vehicle is a vehicle that utilizes electric motors for propulsion. The electric vehicle is therefore powered by an electric source, which can take many different forms. In one embodiment all, or at least part, of the energy required to propel the vehicle may be derived from solar energy that is converted to electric energy. This is usually achieved by using solar panels, more particularly photovoltaic panels that convert the solar energy into direct current electricity using semiconducting materials that exhibit the photovoltaic effect.

An electric vehicle that is powered completely or at least significantly by solar energy is referred to as a solar vehicle. The technology described in this specification is, however, not limited to use in solar vehicles, and will find application in any vehicle utilizing solar panels to at least some extent, whether as primary energy source or as an energy augmentation source. The term ‘electric vehicle’ is therefore used in the specification, and should be interpreted to describe any vehicle that includes a solar panel to at least partially augment its power.

Solar panels are often configured to be able to track the movement of the sun in order to minimize the angle of incidence between the incoming sunlight and the panel. This increases the efficiency of the solar panel, and a small degree of tracking generally results in a significant increase in efficiency, especially if the sun is at a low point in its diurnal arc.

Electric vehicles capable of some degree of solar tracking are known in the art. In existing embodiments, solar tracking is achieved by displacing an articulated solar panel relative to the body and chassis of the vehicle. For example, US2012/0043143 discloses a solar electric vehicle with a large foldable surface area that can be orientated towards the sun for peak generation of electricity. Solar tracking is achieved by displacing the foldable solar panels relative to the chassis of the vehicle. The vehicle chassis therefore remains stationary, whilst the solar panels are displaced relative to the chassis. A problem associated with independently displaceable solar panel is the complexity and costs associated with the reliable solar tracking and articulation system. An independently displaceable solar panel can also have adverse aerodynamic implications if used while the vehicle is moving.

US2014/0297072 also discloses a solar panel that can be tilted, whilst the panel can also be displaced between a deployed and a stowage position. However, in this example the entire vehicle is tilted using onboard hydraulic jacks that extend from the chassis of the vehicle. It would, however, be readily apparent that this configuration can only be used when the vehicle is stationary. The system proposed in US 2014/0297072 will not improve the efficiency of the vehicle whilst driving. In addition, the proposed configuration requires a completely independent and additional actuation system, which increases the cost and complexity of the vehicle.

CN103481786 discloses a robotic vehicle having a chassis, and an adjustable suspension arrangement provided on each side of the chassis. Each suspension arrangement includes a single actuator that controls the displacement of two wheels relative the chassis by way of two pivotable connecting arms. The four wheels are therefore not independently controllable, with two wheels sharing a common suspension arrangement. The robotic vehicle does include solar panels, but the degree to which they can be tilted is limited due to the four wheels not being independently displaceable. The document does not disclose any intention to use the tilting ability of the vehicle for any form of solar tracking, and the vehicle has accordingly not been designed with this intention in mind, which is for example apparent from the orientation of the solar panels. Tilting of the vehicle will result in the angle of incidence of one panel to improve, but for that of an opposing solar panel to be adversely affected. Further, the body movement has not been designed around an existing car or suspension system, but rather the whole car is designed around the need to traverse a complex and harsh terrain and be adaptable to that terrain, which is really the sole purpose of the inventive suspension-body system.

It is accordingly an object of the invention to provide an electric vehicle that will, at least partially, alleviate the above disadvantages.

It is also an object of the invention to provide an electric vehicle which will be a useful alternative to existing electric vehicles.

### SUMMARY OF THE INVENTION

According to the invention there is provided an electric vehicle including:
a chassis;
a suspension arrangement for connecting the chassis to wheels of the vehicle;
a solar panel securable relative to the chassis;
characterized in that an orientation of at least part of the chassis relative to a plane defined by the wheels of the vehicle can be selectively adjusted by adjusting the suspension arrangement, in order for the angular orientation of the solar panel also to be adjusted.

In one embodiment there is provided for the entire chassis of the vehicle to be displaceable relative to the plane defined by the wheels of the vehicle, and in alternative embodiment there is provided for only a part of the chassis of the vehicle to be displaceable relative to the plane defined by the wheels of the vehicle.

There is provided for the solar panel to be secured to the chassis, or for the solar panel to be secured to a vehicle body that is in turn secured to the chassis.

In a preferred embodiment the solar panel is rigidly secured to the chassis or the vehicle body, in order for the solar panel not to be displaceable relative to the chassis or the vehicle body.

There is provided for the suspension arrangement to include a plurality of suspension subsets, with each suspension subset being associated with a separate wheel of the vehicle.

Preferably, each suspension subset is independently adjustable. More particularly, an effective height of each suspension subset is preferably independently adjustable.

There is provided for an effective height of each suspension subset to be adjustable, in order for upper extremities of the suspension subset to define a plane that can be angularly displaced relative to a plane defined by the wheels of the vehicle, and thus relative to the surface on which the vehicle is located.

There is provided for the effective height of the suspensions subsets on a first side of the vehicle to be increased while the effective height of the suspensions subsets on a second side of the vehicle is decreased in order for the chassis to be displaceable in an oscillating or seesaw manner.

In one embodiment there is provided for the chassis to be pivotably mounted relative to the wheel, and more particularly for the chassis to be mounted on a longitudinal mechanical pivot provided between the chassis and an axle of the vehicle in order to allow the chassis to be displaceable in an oscillating or seesaw manner.

The suspension arrangement may be pneumatically, hydraulically or mechanically adjustable.

In the case of the suspension arrangement being pneumatically or hydraulically adjustable, there is provided for a working fluid of the suspension arrangement to be displaceable from the suspension subsets on a first side of the vehicle to the suspension subsets on a second side of the vehicle and vice versa, so as to allow the chassis to be displaceable in an oscillating or seesaw manner.

In one embodiment the suspension subset may include a height adjustment arrangement located between a shock absorber of the subset and the chassis, or alternatively between the shock absorber and a connecting rod of the suspension subset.

The height adjustment arrangement may include a piston and cylinder arrangement, and the effective length of the piston and cylinder arrangement may be adjusted in order to adjust the effective height of the suspension subset.

The height adjustment arrangement may include an threaded rod extending from the shock absorber, and a complementary adjustment nut that can be adjusted to adjust the effective length of the threaded rod, and hence the effective height of the suspension subset.

There is provided for the solar panel to be a non-concentrating solar panel, preferably a photo-voltaic panel, more preferable a flat photo-voltaic panel or a photo-voltaic panel that conforms to the vehicle body contour.

The vehicle may also include a sun sensor for automatically determining the position of the sun relative to the vehicle.

There is also provided for the vehicle to include a control system, the control system being adapted to receive a signal from the sun detector as an input signal, to calculate the required orientation of the vehicle, and to generate a displacement signal for the suspension arrangement.

### BRIEF DESCRIPTION OF THE DRAWINGS

Preferred embodiments of the invention are described by way of non-limiting examples, and with reference to the accompanying drawings in which:

FIG. 1 is a perspective view of an electric vehicle, more particularly a typical solar vehicle, as is known in the art;

FIG. 2 is a cross-sectional view of a suspension arrangement of an electric vehicle in accordance with the invention;

FIG. 3 is a schematic representation of a first height adjustment arrangement in accordance with one embodiment of the invention;

FIG. 4 is a schematic representation of a second height adjustment arrangement in accordance with another embodiment of the invention;

FIG. 5 is a schematic representation of a third height adjustment arrangement in accordance with another embodiment of the invention.

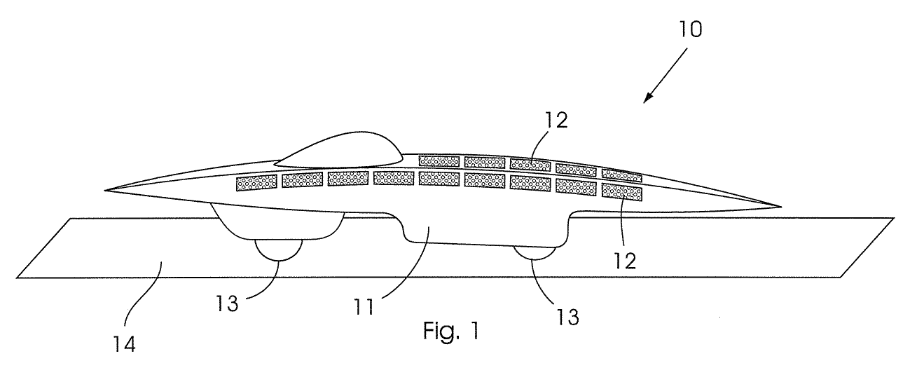

### DETAILED DESCRIPTION OF INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “coupled” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words of similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Referring to the drawings, in which like numerals indicate like features, a non-limiting example of an electric vehicle in accordance with the invention is generally indicated by reference numeral 10.

The electric vehicle 10 comprises a chassis 11 which is connected to wheels 13 of the vehicle 10 by way of a suspension arrangement (not shown). In this example the chassis 11 is integrally formed with a body of the vehicle, and no discrete chassis and body can therefore be identified. A plurality of solar panels 12, and more preferably photovoltaic panels, are secured to, or mounted on, the chassis or body 11 of the vehicle 10, and provides the necessary energy to propel the vehicle 10 relative to a road 14 that the vehicle is positioned on.

The electric vehicle 10 in accordance with this invention includes a new and inventive suspension arrangement 20 that enables the chassis 11 to be selectively displaceable relative to the wheels 13. Each wheel 13 is associated with its own suspension arrangement subset, and each of these suspension arrangement subsets is independently displaceable relative to the wheel 13 to which it is secured. This is important, because the intention is not merely to lift or lower the chassis 11 relative to the wheels 13, but rather selectively to tilt the chassis 11 relative to a plane defined by the wheels 13 (e.g. plane between the centerlines of the wheels), and therefore relative to a road 14 on which the vehicle 10 is located. This will in turn result in the solar panel 12 secured to the chassis 11 to be likewise tilted relative to the road 14, and therefore for the angle of incidence of the solar rays relative to the solar panels 12 to be adjustable. The independent adjustment of the suspension subsets results in the chassis or body to be tiltable in many different planes/about many axes. This is important for the purposes of solar tracking, as it enables the vehicle more accurately to track the sun so as to maintain an optimal solar incidence angle.

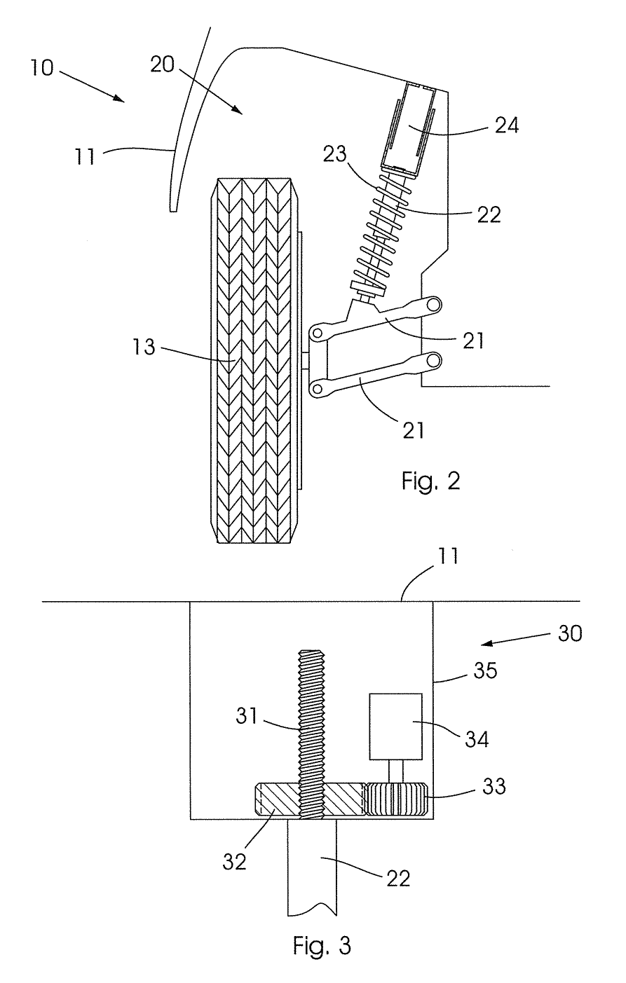

In one embodiment, the suspension arrangement 20 of the electric vehicle 10, as shown in FIG. 2, will include the standard components associated with standard suspension arrangements, but will then in addition also include a further height adjustment arrangement 24. The suspension arrangement 20 typically includes connecting arms 21, which may for example be in the form of a wishbone structure or control arms, or any other functionally similar derivative. The connecting arms 21 are hinged suspension links between the wheel 13 and the chassis 11. In this embodiment, one of the connecting arms 21 is then also connected to the chassis 11 by way of a shock absorber 22 as well as a coil spring 23, which is in this example secured to an upper connecting arm 21. In terms of this invention, the effective distance between the chassis 11 and the connecting arm 21 is selectively adjustable (in addition to the automatic height adjustment resulting from the resilient nature of the suspension arrangement), which enables the position of the chassis relative to the connecting arm 21 and hence the wheel 13 to be adjustable. The height adjustment arrangement 24 may take many different arrangements, and a few embodiments are described in more detail below.

A mechanical adjustment arrangement 30 is shown in FIG. 3. In this example, an elongate, threaded lead screw 31 extends from the shock absorber 22 at the end of the shock absorber proximate the chassis 11. A complementary threaded lead screw nut 32 engages the lead screw 31 in order for rotation of the nut 32 to result in longitudinal displacement of the lead screw 31. This effectively results in the end of the shock absorber 22 being displaceable relative to the chassis 11, and more particularly to a housing 35 in which the mechanical adjustment arrangement 30 is housed. In one embodiment the lead screw nut 32 may be manually adjusted, but in a preferred embodiment the lead screw nut 32 is rotated by way of a motor gear 33, which is in turn driven by an electrical motor 34.

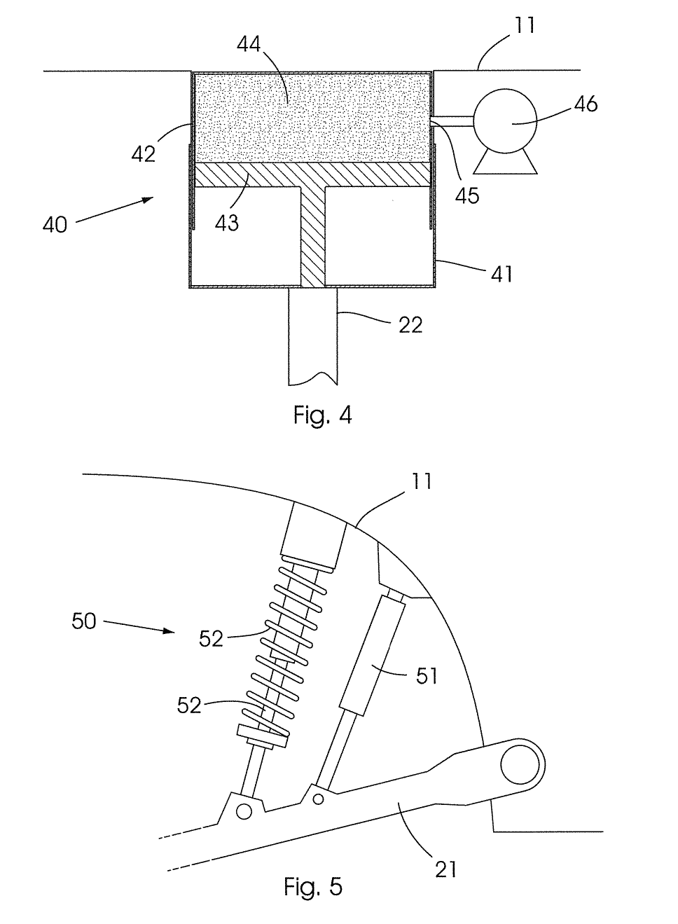

A pneumatic or hydraulic adjustment arrangement 40 is shown in FIG. 4. In this particular embodiment, the adjustment arrangement 40 includes an outer cup 41, which is secured to an end of the shock absorber 22, and an inner cup 42 which is secured to the chassis 11 of the vehicle 10. A piston arrangement 43 extends from a base of the outer cup 41, and is slidably displaceable relative to the inner cup 42, and more particularly an inner surface of the inner cup, so as to define a piston and cylinder arrangement. The cavity 44 between the piston 43 and a base of the inner cup 42 can now selectively be pressurised or depressurised so as to displace the outer cup 41 relative to the inner cup 42, and hence the chassis 11 relative to the end of the shock absorber 22.

A further pneumatic adjustment arrangement 50 is shown in FIG. 5. In this case the suspension arrangement 20 includes a shock absorber 51, as well as a pneumatic bag or actuator 52 that forms part of the vehicle's standard pneumatic suspension arrangement. In this case, the control system of the vehicle 10 is configured to adjust the pressure inside the pneumatic bag 52 so as to lower or raise the pneumatic bags 52 of the four suspension subsets, so as to displace the chassis 11 of the vehicle to a required angle. In accordance with the invention, the four pneumatic bags will be independently adjustable, as opposed to prior art configurations where the pneumatic bags are only selectively adjustable as a single group, or as front and rear groups in order to increase or decrease the clearance of the vehicle. In accordance with this particular embodiment the existing mechanical components may be utilized, but the control system will be changed significantly in order for the pneumatic bags to be independently adjustable in order to adjust the angle of the vehicle, and not only the height. The configuration may also be such that the air from an actuator 52 to be lifted may be supplied from one of the other actuators, therefore resulting in such actuator to be concomitantly lowered. This will result in a seesaw or oscillating displacement between the two opposing actuators, and the alteration of the plane of the chassis will be a more efficient process.

The use of shape-memory alloys to adjust the height of the chassis 11 is also foreseen.

In one example, the chassis of the vehicle, and more particularly the suspension arrangement of the vehicle, can in use be adjusted based on the route to be traveled and the time of travel i.e. based on the predetermined geometrical relationship between the vehicle and the sun for the specific journey. For example, if it is known that the bulk of a journey will be driven from east to west in the southern hemisphere, the vehicle will be adjusted so that it tilts to the right hand side. In such an example no solar tracking system would be required, as the angle of the chassis will be preset. However, it will be appreciated that the vehicle can also be designed in order for the suspension arrangement to be automatically adjusted by way of a feedback control system, in which case the vehicle will include a solar tracking arrangement. The control system may also include an algorithm for maintaining optimal aerodynamics while tilted. This will also be helpful when the vehicle is in a parked position for an extended period, as this will enable the solar panels to track the sun more efficiently due to a potentially greater allowable stationary tilting angle, and the real time optimization between the chassis orientation and the position of the sun. It will, for example, be possible automatically to adjust the adjustment arrangements in order to alter the effective angular orientation of the suspension arrangement in response to a signal received from a sun sensor, for example a photodiode and/or an incident angle sensor. The required tilting angle and orientation will then be achieved by setting the four independent suspension arrangement subsets of the vehicle at respective heights required to result in a desired inclined plane. The tilt angle may be up to 30 degrees when the vehicle is stationary, but will more likely be between 0 and 10 degrees when the vehicle is in motion.

The primary objective that is achieved by this invention is the increased efficiency resulting from the solar panel tracking, while minimizing adverse effects on, not affecting or even improving aerodynamics and handling of the vehicle, and also without introducing the complexity of an independently articulated solar panel. The invention has been implemented on a solar racing car, but the inventive concept can equally be applied to electric commuter vehicles.

A further objective that is achieved by this invention is to reduce the work required to alter the angular orientation of the chassis. As mentioned above, in order to reduce the energy used in tilting the vehicle towards the sun, a seesaw effect can be utilised (where one side of the vehicle drops as the other is raised, thereby drastically reducing the energy required to tilt). This might be particularly applicable to certain trucks and truck trailers, where they are very heavy and wherein a longitudinal mechanical pivot might be incorporated between the axels and the chassis, or part thereof. Another such system would involve an equivalent of the seesaw approach, but on vehicles with air suspension. If air is pumped from the suspension on one side of the car to that on the other (directly), the car will tilt in a similar manner to a mechanical seesaw, again with minimal energy requirements. The chassis or body will be lowered on the side where the pneumatic working fluid is removed, and will rise on the side where the working fluid is added. The same will obviously apply for hydraulic systems.

It will be appreciated that the above is only one embodiment of the invention and that there may be many variations without departing from the spirit and/or the scope of the invention. For example, even though the illustrated embodiments indicate configurations where the entire chassis of the vehicle is displaced, it is also foreseen that only a part of the vehicle's body or chassis can be tilted, such as only a trailer of a truck or only part of a trailer of a truck.

1-14. (canceled)

15. An electric vehicle including:
a chassis;
a suspension arrangement for connecting the chassis to wheels of the vehicle;
a solar panel securable relative to the chassis;
wherein an orientation of the vehicle chassis or body relative to a plane defined by the wheels of the vehicle can be selectively adjusted by adjusting the suspension arrangement, in order for the angular orientation of the solar panel also to be adjusted; and
a solar tracking arrangement for use in adjusting the suspension arrangement of the vehicle in order for the solar panel secured relative to the chassis at least partially to track the position of the sun.

16. The electric vehicle of claim 15 in which the solar panel is secured to the chassis, or to a vehicle body that is in turn secured to the chassis.

17. The electric vehicle of claim 16 in which the solar panel is rigidly secured to the chassis or to the vehicle body that is in turn rigidly secured to the chassis, in order for the solar panel not to be displaceable relative to the chassis or to the vehicle body.

18. The electric vehicle of claim 16 in which the suspension arrangement includes a plurality of suspension subsets, with each suspension subset being associated with a separate wheel of the vehicle.

19. The electric vehicle of claim 18 in which each suspension subset is independently adjustable.

20. The electric vehicle of claim 19 in which an effective height of each suspension subset is independently adjustable.

21. The electric vehicle of claim 20 in which the effective height of each suspension subset is adjustable in order for upper extremities of the suspension subset to define a plane that can be angularly displaced relative to a plane defined by the wheels of the vehicle, and thus relative to the surface on which the vehicle is located.

22. The electric vehicle of claim 16 in which the suspension arrangement is pneumatically, hydraulically or mechanically adjustable.

23. The electric vehicle of claim 22 in which the suspension arrangement includes a plurality of suspension subsets, with each suspension subset being associated with a separate wheel of the vehicle, and with each suspension subset independently adjustable.

24. The electric vehicle of claim 23 in which each suspension subset includes a height adjustment arrangement located between a shock absorber of the subset and the chassis, or alternatively between the shock absorber and a connecting rod of the suspension subset.

25. The electric vehicle of claim 23 in which the chassis is pivotably mounted relative to the wheels.

26. The electric vehicle of claim 15 in which the chassis is pivotably mounted relative to the wheels.

27. The electric vehicle of claim 25 in which the chassis is mounted on a longitudinal mechanical pivot provided between the chassis and an axle of the vehicle in order to allow the chassis to be displaceable in an oscillating or seesaw manner.

28. The electric vehicle of claim 16 in which the chassis is mounted on a longitudinal mechanical pivot provided between the chassis and an axle of the vehicle in order to allow the chassis to be displaceable in an oscillating or seesaw manner.

29. The electric vehicle of claim 18 in which the suspension arrangement is pneumatically or hydraulically adjustable, and wherein there is provided for a working fluid of the suspension arrangement to be displaceable from the suspension subsets on a first side of the vehicle to the suspension subsets on a second side of the vehicle and vice versa, so as to allow the chassis to be displaceable in an oscillating or seesaw manner.

30. The electric vehicle of claim 15 in which the solar tracking arrangement includes a sensor for determining the position of the sun relative to the vehicle, and a control system adapted to receive a signal from the sensor as an input signal, to calculate the required orientation of the vehicle, and to generate and implement a displacement signal for the suspension arrangement.
